(19) United States
(12) Patent Application Publication
(10) Pub. No.: US 2019/0130316 A1
(43) Pub. Date: May 2, 2019

(54) APPARATUS, MANAGEMENT SYSTEM, AND NON-TRANSITORY COMPUTER READABLE MEDIUM

(71) Applicant: FUJI XEROX CO.,LTD., Tokyo (JP)

(72) Inventors: Kengo TOKUCHI, Kanagawa (JP); Takatoshi BABA, Kanagawa (JP)

(73) Assignee: FUJI XEROX CO.,LTD., Tokyo (JP)

(21) Appl. No.: 16/109,678

(22) Filed: Aug. 22, 2018

(30) Foreign Application Priority Data
Oct. 26, 2017 (JP) 2017-207330

(51) Int. Cl. G06Q 10/02

(52) U.S. Cl. CPC G06Q 10/02

(57) ABSTRACT

An apparatus includes a limiting unit that, if a user who has used a space reenters the space after a reservation period ends, limits functions available in the space after reentry.

### CROSS-REFERENCE TO RELATED APPLICATIONS

This application is based on and claims priority under 35 USC 119 from Japanese Patent Application No. 2017-207330 filed Oct. 26, 2017.

### BACKGROUND

### Technical Field

The present invention relates to an apparatus, a management system, and a non-transitory computer readable medium.

### SUMMARY

According to an aspect of the invention, there is provided an apparatus including a limiting unit that, if a user who has used a space reenters the space after a reservation period ends, limits functions available in the space after reentry.

### BRIEF DESCRIPTION OF THE DRAWINGS

An exemplary embodiment of the present invention will be described in detail based on the following figures, wherein:

FIG. 1 is a diagram schematically illustrating an example of the overall configuration of a management system;

FIG. 2 is a diagram illustrating an example of the appearance of a time-based rental space used by users;

FIG. 3 is a diagram illustrating an example of the hardware configuration of a user terminal;

FIG. 4 is a diagram illustrating an example of the hardware configuration of a server included in the management system;

FIG. 5 is a diagram illustrating an example of the configuration of the time-based rental space included in the management system;

FIG. 6 is a diagram illustrating an example of the software configuration of a control device;

FIG. 7 is a diagram illustrating an example of the software configuration of a user terminal operated by a user who issues a reentry request;

FIG. 8 is a diagram illustrating an example of the software configuration of a user terminal operated by a next user of the time-based rental space;

FIG. 9 is a diagram illustrating an example of a control operation performed by a reentry control unit;

FIG. 10 is a diagram illustrating limitation of illuminance;

FIG. 11 is a diagram illustrating an open state;

FIG. 12 is a diagram illustrating an example in which a reservation period of Mr. B has not started when Mr. A issues a reentry request;

FIG. 13 is a diagram illustrating an example of a chat screen for reservation displayed, during a control process, on a display device of a user terminal owned by Mr. A, who has issued a reentry request;

FIG. 14 is a diagram illustrating an example in which a reservation period of Mr. B has started when Mr. A issues a reentry request but Mr. B has not started using the time-based rental space;

FIG. 15 is a diagram illustrating an example of a chat screen for reservation displayed on the display device of the user terminal 4 owned by Mr. A, who has issued the reentry request;

FIG. 16 is a diagram illustrating an example of a chat screen for reservation displayed on a display device of a user terminal owned by Mr. B, who has received a notification of the issuance of the reentry request;

FIG. 17 is a diagram illustrating an example in which a reservation period of Mr. B has started and Mr. B has started using the time-based rental space when Mr. A issues a reentry request;

FIG. 18 is a diagram illustrating a chat screen for reservation displayed on the display device of the user terminal owned by Mr. B, who has received a notification of the issuance of the reentry request;

FIG. 19 is a diagram illustrating an example of a chat screen for reservation displayed on the display device of the user terminal owned by Mr. A, who has issued the reentry request; and

FIG. 20 is a diagram illustrating an example of the configuration of another management system.

### DETAILED DESCRIPTION

An exemplary embodiment of the present invention will be described hereinafter with reference to the drawings.

### Exemplary Embodiment

### Overall Configuration of Management System

As communication speed improves and communication terminals are reduced in size, various pieces of information can now be accessed from outside offices in many environments. Because business conversations and information are highly confidential, on the other hand, such environments need to be quiet and secure.

A management system for providing spaces that satisfy these requirements will be described in the present exemplary embodiment. The spaces that will be described hereinafter, however, may be used privately, instead for business purposes.

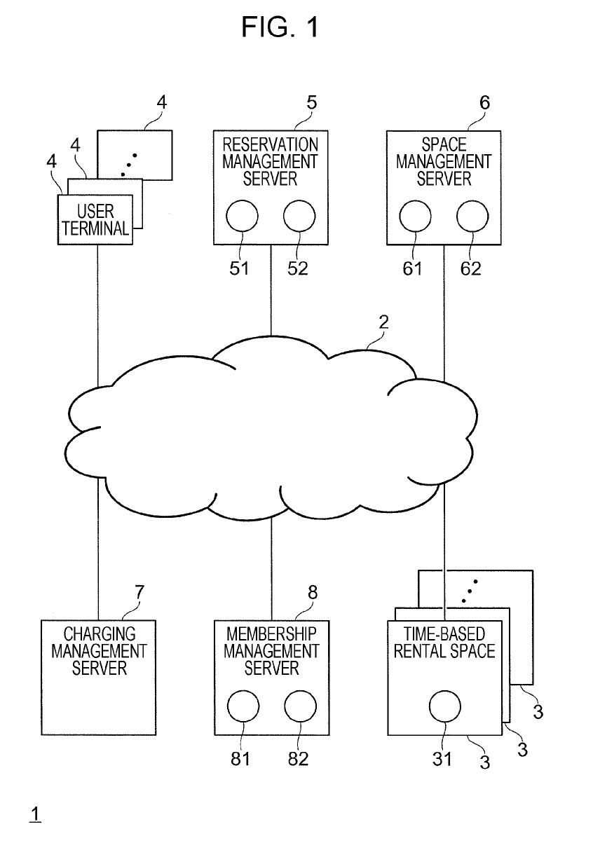

FIG. 1 is a diagram schematically illustrating an example of the overall configuration of a management system 1.

As illustrated in FIG. 1, the management system 1 includes various terminals connected to a cloud network 2.

FIG. 1 illustrates, as an example of the terminals included in the management system 1, plural time-based rental spaces 3, plural user terminals 4 carried by users who use the time-based rental spaces 3, a reservation management server 5 that manages reservations of the time-based rental spaces 3, a space management server 6 that manages use conditions of the time-based rental spaces 3, a charging management server 7 that manages charging of the users, and a membership management server 8 that manages information regarding members who can use the time-based rental spaces 3.

The time-based rental spaces 3 according to the present exemplary embodiment can be used every day around the clock except for maintenance time and the like.

Although one server is prepared for each purpose (function) in FIG. 1, plural servers may be prepared for each purpose, instead. Alternatively, a single server may achieve plural purposes (functions).

One or plural organizations may provide a time-based rental service of the time-based rental spaces 3. Different organizations may manage, for example, reservations, entry, exit, and use conditions of the time-based rental spaces 3, charging of the users, and members registered as users. Plural organizations may cooperatively achieve one of these purposes (functions), instead.

In addition, plural servers may be prepared for each purpose (function). When a single organization prepares plural servers for each purpose (function) or plural servers corresponding to plural purposes (functions), the servers may be connected to one another through an intranet.

In addition, one or plural organizations may provide the time-based rental spaces 3.

That is, the management system 1 may be achieved as an aggregation of services provided by plural organizations.

In the present exemplary embodiment, electronic keys are used for locking and unlocking. The electronic keys are stored in the user terminals 4 or integrated circuit (IC) cards capable of performing near-field communication. When a user terminal 4 is used as an electronic key, the reservation management server 5 provides an electronic key for the user terminal 4 after a reservation is confirmed. When an IC card is used as an electronic key, the reservation management server 5 provides an IC card storing an electronic key after a reservation is confirmed.

When electronic keys are used, time periods for which locking and unlocking can be effectively performed can be freely determined. In addition, plural electronic keys for using a certain time-based rental space 3 can be issued for the same time period.

Alternatively, plural physical keys may be prepared for reservation periods, and a time-based rental space 3 may be locked and unlocked. Alternatively, authentication of the users may be performed instead of, or in addition to, the use of electronic keys or physical keys.

The reservation management server 5 manages, for example, a registration list 51 in which available time-based rental spaces 3 are registered and a reservation list 52 that manages assignment of users who desire to use the time-based rental spaces 3.

In the present exemplary embodiment, the reservation management server 5 accepts reservations of the time-based rental spaces 3 every day around the clock except for maintenance time and the like. The reservation management server 5 also issues electronic keys for the user terminals 4 and authenticates the user terminals 4 as necessary. The space management server 6 may perform the authentication, instead.

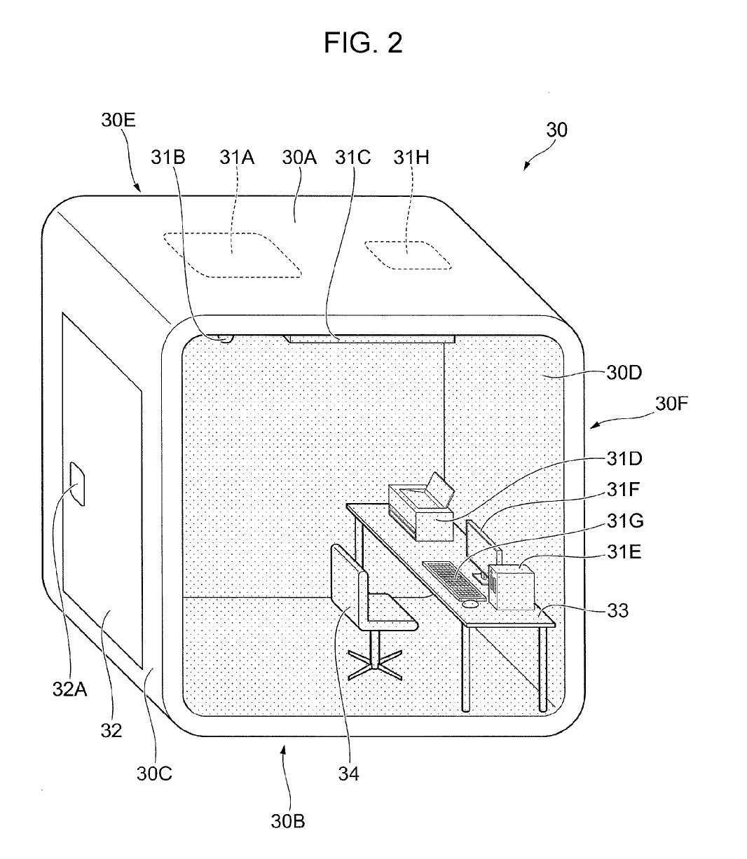

The space management server 6 manages entry and exit information 61 and use condition information 62 regarding the time-based rental spaces 3. The space management server 6 also has a function of communicating with an authentication unit 32A (refer to FIG. 2) provided for each time-based rental space 3 and determining whether to permit a user to enter the time-based rental space 3. During the authentication, the space management server 6 communicates with the reservation management server 5.

The space management server 6 also has a function of collecting information from various devices 31 provided in each time-based rental space 3 and controlling the devices 31.

Although the space management server 6 is connected to the cloud network 2 in the example illustrated in FIG. 1, the time-based rental spaces 3 may achieve some or all of the functions achieved by the space management server 6, instead.

The charging management server 7 has a function of submitting a bill to each member (a natural person or a corporation) on the basis of reservation information, user information, entry and exit information, and the like. The charging management server 7 obtains the reservation information from the reservation management server 5, the entry and exit information from the space management server 6, and the membership information from the membership management server 8.

The membership management server 8 manages registered membership information and user information. When members are natural persons, the members and users match. When members are corporations, on the other hand, individual users are registered for each member and managed.

FIG. 2 is a diagram illustrating an example of the appearance of a time-based rental space 3 used by the users.

The time-based rental space 3 according to the present exemplary embodiment is installed in, for example, a station, an airport, an office building, a commercial institution such as a restaurant or a department store, a bank, a library, an art gallery, a museum, a public facility or institution, a corridor, a park, or any other indoor or outdoor area.

A soundproof chamber is assumed as the time-based rental space 3 in the present exemplary embodiment. The time-based rental space 3 is an example of a closed space in this sense. In the present exemplary embodiment, “closed” does not mean sealed but means presence of practical soundproofing properties. An opening or a gap such as a vent or a small window may therefore be provided for a framework 30 of the time-based rental space 3.

The framework 30 according to the present exemplary embodiment includes a ceiling 30A, a floor 30B, a wall 30C on which a door 32 is provided, two walls 30D and 30E located on sides of the wall 30C, and a wall 30F opposite the door 32.

The door 32 is a swing door including one leaf that opens in an arc only in one direction in the present exemplary embodiment. Alternatively, the door 32 may be a double door, that is, the door 32 may include two leaves for a single opening.

Alternatively, the door 32 may be a sliding door. The sliding door may be a single sliding door, a double sliding door, or a sliding door including three or more leaves.

Alternatively, the door 32 may be a folding door including two leaves connected to each other by a hinge. The folding door may open in one direction or two directions.

Alternatively, the door 32 may be of a special type, such as a sliding door that can be stored inside a wall or a partition door.

The door 32 may open outward or inward.

In the present exemplary embodiment, part of the walls 30D and 30E is composed of a transparent material (e.g., glass or an acrylic resin).

Alternatively, at least part of the walls 30D and 30E may employ a structure, a material, or a type of working that screens the time-based rental space 3 (makes it difficult to observe the inside or decreases visibility).

The walls 30D and 30E may be, for example, composed of a translucent material, formed of members whose surfaces are ground so that light scatters thereon, or may be provided with film-like members having a similar function. The film-like members may be liquid crystal films that electrically switches between a transparent state and a frosted state or polarizing films capable of electrically adjusting transmittance.

Alternatively, a structure or a member for screening may be separately prepared. Alternatively, the walls 30D and 30E may be composed of an opaque material as with other surfaces. Alternatively, three or more surfaces may be composed of a transparent or translucent material.

The number of persons accommodated by the time-based rental space 3 is substantially determined on the basis of the volume of the time-based rental space 3. Although the time-based rental space 3 is a private room and basically used by one person at a time in the present exemplary embodiment, the time-based rental space 3 may be a large room that can accommodate a large number of persons. The time-based rental spaces 3 may be configured as separate rooms, or may be connected to one another by removing the walls 30D and/or the walls 30E thereof.

The time-based rental space 3 as a private room need not necessarily be used by one person at a time but may be used by a couple of persons, namely two to three persons, instead.

The shape and structure of the framework 30 that forms the time-based rental space 3 and types and performance of equipment to be provided may be arbitrarily determined.

In the present exemplary embodiment, a desk 33 and a chair 34 are provided inside the framework 30. A printing device 31D, a computer 31E, a display device 31F, and an input device 31G, which are an example of devices 31, are provided on the desk 33. Data and information regarding a history stored in the computer 31E are all deleted by the system after use in order to protect privacy.

The devices 31 also include an air conditioner 31A, a human detection sensor 31B, a lighting device 31C used to illuminate the time-based rental space 3, a control device 31H that controls the operation of electronic devices including the devices 31, and an authentication unit 32A.

The specific electronic devices described above as the devices 31 are examples. For example, the printing device 31D, the computer 31E, the display device 31F, and the input device 31G on the desk 33 need not be provided. In this case, a user's computer or smartphone is used.

The entirety (includes the framework 30) of the time-based rental space 3 or the control device 31H is an example of an apparatus in the claims. The control device 31H is also an example of a controller in the claims.

In addition, the user terminals 4, the reservation management server 5, the space management server 6, the charging management server 7, and the membership management server 8 are examples of an apparatus in the claims.

In addition, the management system 1 is an example of a management system in the claims.

### Configuration of Terminals

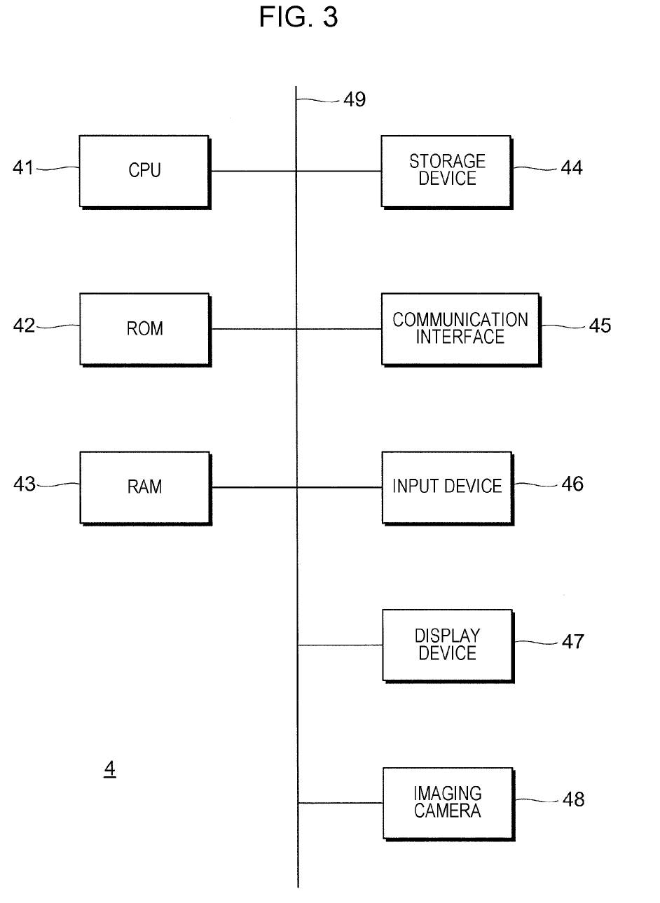

An example of the configuration of the terminals included in the management system 1 will be described with reference to FIGS. 3 to 5.

FIG. 3 is a diagram illustrating an example of the hardware configuration of a user terminal 4.

In the present exemplary embodiment, a smartphone, for example, is used as the user terminal 4.

The user terminal 4 includes a central processing unit (CPU) 41 that provides various functions through firmware and application programs, a read-only memory (ROM) 42, which is a storage area storing the firmware and a basic input/output system (BIOS), and a random-access memory (RAM) 43, which is an area in which the programs are executed.

The user terminal 4 also includes a volatile storage device 44 storing downloaded application programs, electronic keys, and the like, a communication interface 45 used to communicate with the outside, an input device 46 such as a touch panel, a display device 47 used to display information, and an imaging camera 48. The storage device 44 is achieved by, for example, a semiconductor memory.

The CPU 41 is connected to the various devices through a bus 49.

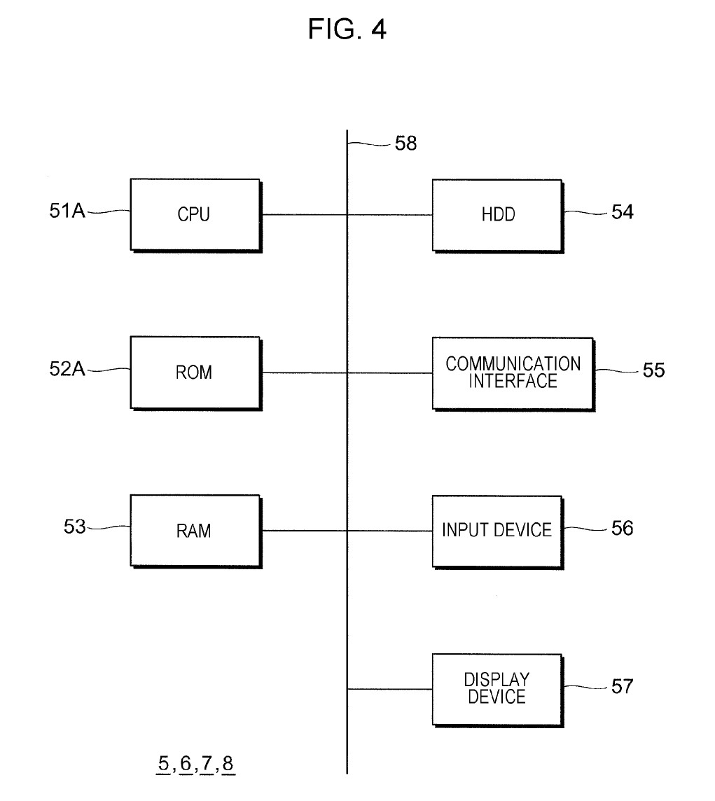

FIG. 4 is a diagram illustrating an example of the hardware configuration of a server included in the management system 1.

FIG. 4 illustrates the configuration of the reservation management server 5 as an example. The other servers, namely the space management server 6, the charging management server 7, and the membership management server 8, have the same configuration as that illustrated in FIG. 4.

The reservation management server 5 includes a CPU 51A that provides various management functions through an operating system and application programs, a ROM 52A, which is a storage area storing the operating system and a BIOS, and a RAM 53, which is an area in which the programs are executed.

The reservation management server 5 also includes a volatile hard disk drive (HDD) 54 storing the application programs for achieving the management functions and various pieces of management data, a communication interface 55 used to communicate with the outside, an input device 56 such as a keyboard, and a display device 57 used to display information.

The CPU 51A and the various devices are connected to one another through a bus 58.

The servers are an example of databases storing management data.

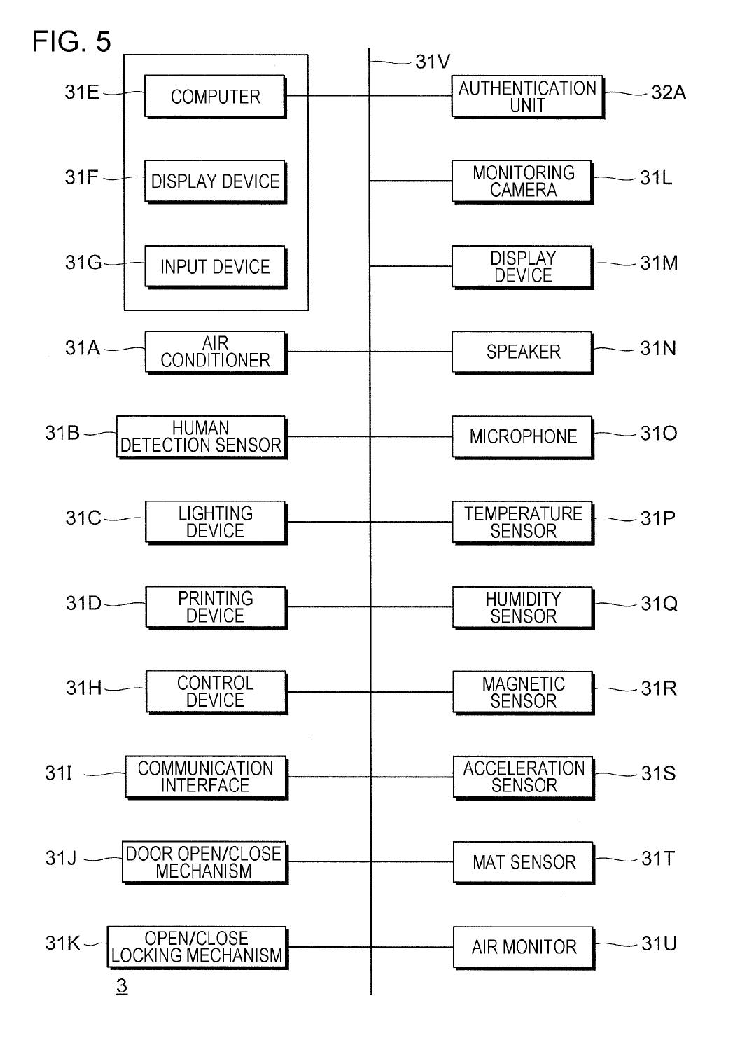

FIG. 5 is a diagram illustrating an example of the configuration of a time-based rental space 3 included in the management system 1.

The time-based rental space 3 includes the air conditioner 31A, the human detection sensor 31B, the lighting device 31C, the printing device 31D, the computer 31E, the display device 31F, the input device 31G, the control device 31H, and the authentication unit 32A.

The air conditioner 31A is used to adjust temperature and humidity inside the time-based rental space 3. A mechanism specialized in ventilation may be incorporated into, or provided separately from, the air conditioner 31A.

The human detection sensor 31B is a sensor used to detect a person inside the time-based rental space 3 and can be one of various types. The human detection sensor 31B can be, for example, a pyroelectric infrared human detection sensor capable of detecting human motion, an image human detection sensor or a thermopile human detection sensor capable of detecting the number and positions of persons. One or some of these sensors may be used in accordance with purposes.

The printing device 31D, the computer 31E, the display device 31F, and the input device 31G are an example of information devices prepared inside the time-based rental space 3 and used by users. These devices are connected to one another through a local area network (LAN) 31V (e.g., a LAN cable or a wireless LAN). When a user brings a computer into the time-based rental space 3, the computer is connected to the LAN 31V. Wi-Fi (registered trademark) or Bluetooth (registered trademark), for example, is used for the wireless LAN.

The control device 31H is a control computer that collects information from the devices connected to the LAN 31V and that controls the operation of the devices. Depending on a type of management system 1, the control device 31H might serve as the space management server 6.

The authentication unit 32A is mounted on, for example, the door 32. The authentication unit 32A is used to obtain and transmit information necessary to lock and unlock the door 32. Authentication is performed by the reservation management server 5, for example, and only a result of the authentication is transmitted to the authentication unit 32A. If the authentication has been successfully completed, the authentication unit 32A unlocks the door 32. After the unlocking, the door 32 can be opened, and a user can enter the time-based rental space 3 (refer to FIG. 2).

A communication interface 311 for communicating with the outside is also provided for the time-based rental space 3. The communication interface 311 is connected to the cloud network 2 (refer to FIG. 1) and used to communicate with the various servers.

A door open/close mechanism 31J that mechanically opens and closes the door 32 is provided for the time-based rental space 3. The door open/close mechanism 31J includes, for example, a mechanism for driving the door 32 to open and close the door 32 and a mechanism for adjusting the amount of load needed to open or close the door 32 for a user who is opening or closing the door 32.

An open/close locking mechanism 31K is provided for the time-based rental space 3. The open/close locking mechanism 31K is a mechanism that limits opening and closing of the door 32 performed by a user. While the open/close locking mechanism 31K is operating, at least closing of the door 32 is limited.

A monitoring camera 31L used to monitor a user inside and outside the time-based rental space 3 is provided for the time-based rental space 3. The monitoring camera 31L, however, is not a mandatory component.

A display device 31M is provided for the time-based rental space 3. The display device 31M according to the present exemplary embodiment is disposed, for example, on an outside surface of the wall 30C, on which the door 32 is provided, and operated by a user who desires to enter the time-based rental space 3 and provides information for the user. The display device 31M is also operated by a user who is using the time-based rental space 3 and provides information for the user.

A speaker 31N is provided for the time-based rental space 3. The speaker 31N is used to notify a user inside the time-based rental space 3 of information and a person outside the time-based rental space 3 of information. The speaker 31N is an example of a notification unit.

A microphone 310 is provided for the time-based rental space 3. The microphone 310 is used to obtain sound inside the time-based rental space 3.

A temperature sensor 31P is provided for the time-based rental space 3. The temperature sensor 31P is used to measure temperature inside the time-based rental space 3.

A humidity sensor 31Q is provided for the time-based rental space 3. The humidity sensor 31Q is used to measure humidity inside the time-based rental space 3.

A magnetic sensor 31R is provided for the time-based rental space 3. The magnetic sensor 31R is mounted on the door 32 and detects opening and closing of the door 32 through magnetic detection.

An acceleration sensor 31S is provided for the time-based rental space 3. The acceleration sensor 31S is used to detect the motion of things.

A mat sensor 31T is provided for the time-based rental space 3. The mat sensor 31T is used to detect the weight of things and visualize a stay period of a person and crowdedness.

An air monitor 31U is provided for the time-based rental space 3. The air monitor 31U is a sensor that detects constituent parts of air inside the time-based rental space 3 and measures, for example, levels of particulate matter 2.5 (PM2.5) and PM10, carbon dioxide concentration, temperature, humidity, and concentrations of volatile organic compounds. All of these need not be measured, and other constituent parts may also be measured. When the air monitor 31U is capable of measuring temperature and humidity, the temperature sensor 31P and the humidity sensor 31Q need not be provided.

### Control Function

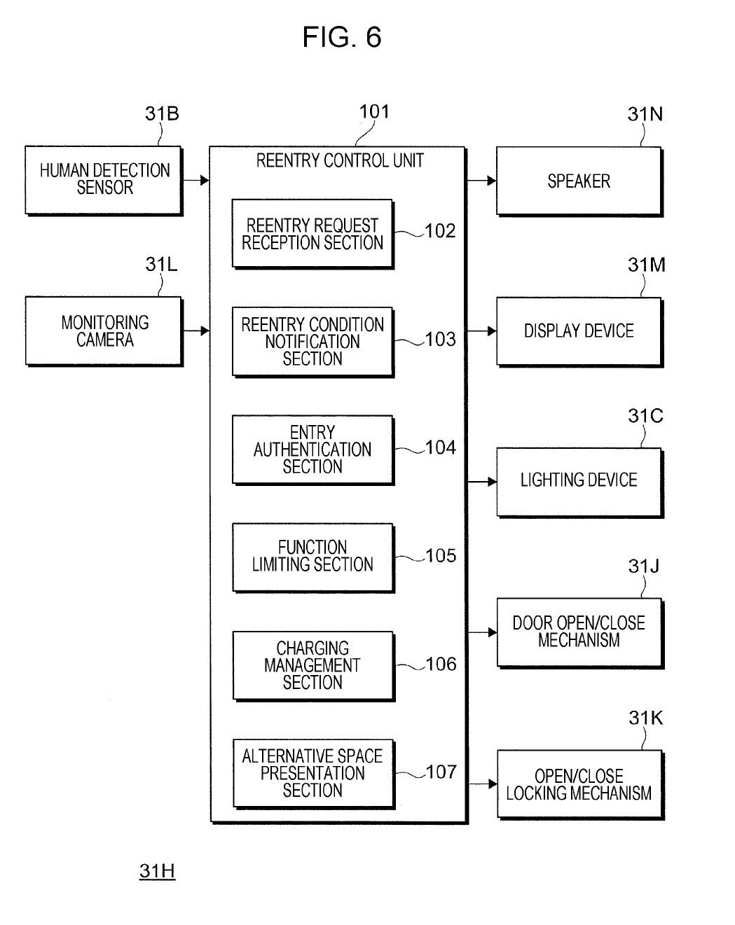

A control function achieved by one or some of the terminals included in the management system 1 will be described with reference to FIG. 6.

A case where the control device 31H independently provides the control function will be described hereinafter.

FIG. 6 is a diagram illustrating an example of the software configuration of the control device 31H.

The control device 31H achieves the functions by executing programs.

The control device 31H according to the present exemplary embodiment has a control function for a case where a person enters the time-based rental space 3 after a reservation period ends (will be referred to as “reentry” in the present exemplary embodiment). In the present exemplary embodiment, this function will be referred to as a “reentry control unit 101”. The reentry control unit 101 is an example of a limiting unit in the claims.

It is assumed in the present exemplary embodiment that a user of the time-based rental space 3 (refer to FIG. 2) issues a reentry request when the user has not returned to the time-based rental space 3 before an end of a reservation period and has been shut out or when the user has left a thing in the time-based rental space 3 (i.e., a case of a lost article). Reasons of reentry are not limited to these two.

The reentry control unit 101 according to the present exemplary embodiment has plural functions.

The reentry control unit 101 includes, for example, a reentry request reception section 102 that receives a reentry request from a user, a reentry condition notification section 103 that notifies a user who has issued a reentry request of reentry conditions, an entry authentication section 104 that authenticates a user, a function limiting section 105 that limits functions after reentry, a charging management section 106 that manages charging after reentry, and an alternative space presentation section 107 that presents an alternative space to a next user as necessary.

The reentry request reception section 102 receives a reentry request (an operation performed on a shutout button or a lost article button) from a user interface (e.g., the display device 31M of a touch panel type) disposed on an outside wall of the time-based rental space 3 or a user terminal 4 (refer to FIG. 1) operated by a user.

The reentry condition notification section 103 notifies a user of reentry conditions in advance and asks the user whether to accept the reentry conditions. This is because reentry is an exceptional case and there is little need to permit a user to stay inside the time-based rental space 3 for a long time. It is sufficient that a user can put things away or retrieve a lost article. In other words, a comfortable, convenient space need not be provided.

The reentry condition notification section 103, therefore, notifies a user of conditions provided by relevant organizations and asks the user whether to accept the conditions.

The entry authentication section 104 provides a function of authenticating a user who desires to reenter the time-based rental space 3. For example, the entry authentication section 104 requests a user to present an electronic key that was valid in a reservation period.

In the present exemplary embodiment, the entry authentication section 104 verifies that a user terminal 4 (e.g., a smartphone) used to enter the time-based rental space 3 in a reservation period and a user terminal 4 used to reenter the time-based rental space 3 are the same in order to make sure that a user who is reentering and a user who was using the time-based rental space 3 are the same person. More specifically, the entry authentication section 104 verifies that a physical address (e.g., a media access control (MAC) address) of the user terminal 4 is the same between the reservation period and the reentry.

If the physical address of the user terminal 4 is the same, the entry authentication section 104 determines that the user who is reentering is the user who was using the time-based rental space 3. This is because it is unlikely that a person lend a user terminal 4 to another person.

The function limiting section 105 disables, after reentry, functions available in the time-based rental space 3 other than predetermined ones. The function limiting section 105 is an example of the limiting unit in the claims.

Various methods may be used to limit functions.

For example, the function limiting section 105 controls the door open/close mechanism 31J and the open/close locking mechanism 31K such that the door 32 (refer to FIG. 2) does not close or, even after being closed, does not lock. That is, the time-based rental space 3 remains in an open state.

For example, the function limiting section 105 disables all the devices other than the lighting device 31C so that a user can easily put things away or retrieve a lost article. That is, the function limiting section 105 disables the functions other than lighting. The function limiting section 105 may limit illuminance to some degree (e.g., 20% of a maximum illuminance) or gradually decrease illuminance as time elapses after reentry.

The charging management section 106 has a function for a case where a stay after reentry becomes longer than expected. Charging is provided in order to suppress an unnecessarily long stay. Reentry of a user is detected through the human detection sensor 31B or the monitoring camera 31L.

A user is notified of charging in advance as a reentry condition and asked to accept the condition. After reentry, the user is notified of a start of the charging before and after the charging actually starts.

The speaker 31N or the display device 31M in the time-based rental space 3, for example, is used for the notification. Alternatively, the user terminal 4 of the user used for reentry is used for the notification.

The function of the charging management section 106 may be achieved by the charging management server 7 (refer to FIG. 1).

The alternative space presentation section 107 is provided in order to present an alternative time-based rental space 3 to a next user who has been scheduled to use the time-based rental space 3 for which a reentry request has been issued.

When a reservation period of a next user is coming or has already started but the next user has not started using the time-based rental space 3, for example, reentry can be permitted and the next user is not inconvenienced if a satisfactory alternative can be presented to the next user.

The alternative space presentation section 107 communicates with the reservation management server 5 (refer to FIG. 1) and presents another time-based rental space 3 that is not reserved in the same period and that is installed near the time-based rental space 3 for which a reentry request has been issued. In the present exemplary embodiment, another time-based rental space 3 that is installed in the same place and that has not been reserved in the same period is presented in order to give priority to a next user's convenience. If there is no such time-based rental space 3, no time-based rental space 3 is presented as an alternative. Alternatively, a time-based rental space 3 in another place may be presented if a next user will accept it.

The function of the alternative space presentation section 107 may be achieved by the reservation management server 5.

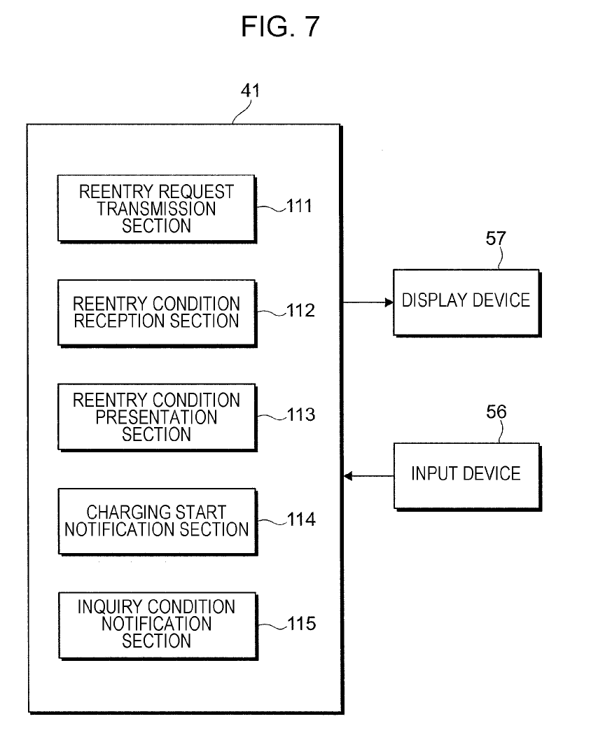

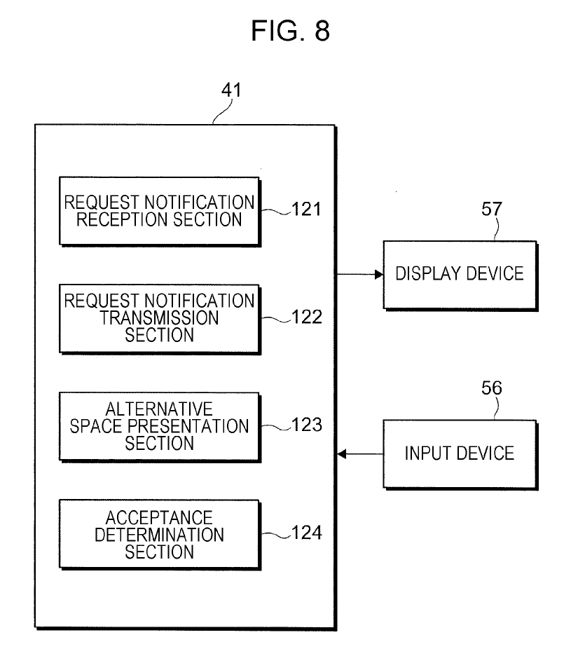

Next, a control function achieved by the user terminals (refer to FIG. 1) will be described with reference to FIGS. 7 and 8.

FIG. 7 is a diagram illustrating an example of the software configuration of a user terminal 4 operated by a user who issues a reentry request. The software configuration is achieved by executing a program using the CPU 41.

The CPU 41 that achieves this software configuration functions as a reentry request transmission section 111 that transmits a reentry request to a service provider, a reentry condition reception section 112 that receives the above-described reentry conditions, a reentry condition presentation section 113 that notifies the user of reentry conditions, a charging start notification section 114 that notifies the user of a start of charging after reentry, and an inquiry condition notification section 115 that notifies the user of an inquiry condition of a next user.

The reentry condition reception section 112 is an example of a reception unit in the claims. The reentry condition presentation section 113 is an example of a notification unit in the claims.

The reentry request transmission section 111 transmits a reentry request message to the service provider, for example, if an operation performed on the shutout button, the lost article button, or the like displayed on the display device 57 of the user terminal 4 is detected. The operation performed on a button is received through the input device 56.

The reentry condition reception section 112 receives reentry conditions presented by the service provider in the form of a message, a voice mail, or the like.

The reentry condition presentation section 113 presents reentry conditions to the user through the display device 57 or a speaker that is not illustrated.

The charging start notification section 114 notifies, through the display device 57 or the speaker that is not illustrated, the user of a start of charging before reentry and after the charging actually starts.

The inquiry condition notification section 115 notifies the user, through the display device 57 or the speaker that is not illustrated, an inquiry condition of a next user when a reservation period of the next user has started but the next user has not started using the time-based rental space 3.

FIG. 8 is a diagram illustrating an example of the software configuration of a user terminal 4 operated by a next user of the time-based rental space 3. This software configuration, too, is achieved by executing a program using the CPU 41.

The CPU 41 that achieves this software configuration functions as a request notification reception section 121 that receives, from the service provider, a notification that a reentry request has been issued, a request notification transmission section 122 that notifies a next user of issuance of a reentry request, an alternative space presentation section 123 that presents an alternative space presented by the service provider to a next user, and an acceptance determination section 124 used to determine whether to accept an alternative space.

The request notification transmission section 122 is an example of a notification unit in the claims. The acceptance determination section 124 is an example of a reception unit in the claims.

The request notification reception section 121 receives a notification that a reentry request has been issued by another user who was using the time-based rental space 3 in the past. An organization transmits this notification as a push notification in the form of a message, a voice mail, or the like.

The request notification transmission section 122 transmits, through the display device 57 or the speaker that is not illustrated, a notification that a reentry request has been issued. In an example of control that will be described later, a user is notified of issuance of a reentry request in presentation of an alternative space.

The alternative space presentation section 123 presents, through the display device 57 or the speaker that is not illustrated, a time-based rental space 3 provided by the service provider as an alternative to the reserved time-based rental space 3.

The acceptance determination section 124 is used to determine whether to accept an alternative time-based rental space 3 and respond to a notification received from the service provider. An operation performed by the user is received through the input device 56.

### Example of Control

An example of control achieved by the reentry control unit 101 (refer to FIG. 6) will be described hereinafter.

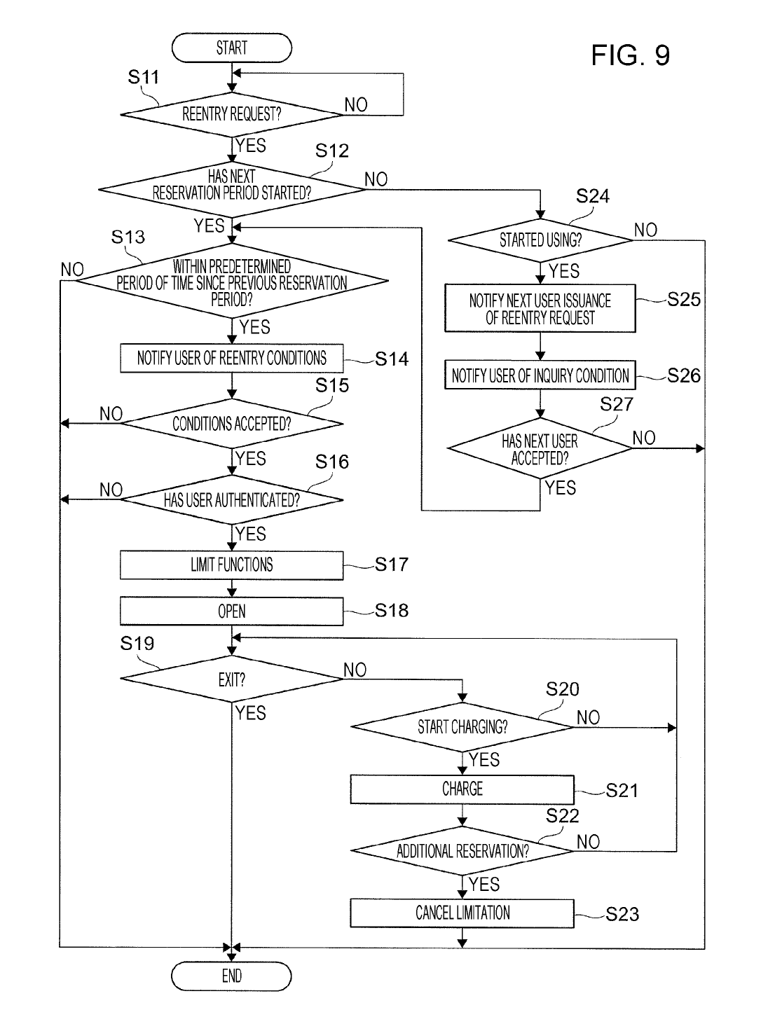

FIG. 9 is a diagram illustrating an example of a control operation performed by the reentry control unit 101.

First, the reentry control unit 101 determines whether a reentry request has been issued (step S11). If an operation is performed on the shutout button, the lost article button, or the like, the reentry control unit 101 determines that a reentry request has been issued.

Step S11 is repeatedly performed until a result thereof becomes positive.

If the result of step S11 becomes positive, the reentry control unit 101 determines whether a next reservation period has started (step S12).

The determination is made, for example, upon receiving the reentry request. Upon receiving the reentry request, the reentry control unit 101 instructs the reservation management server 5 (refer to FIG. 1) to stop receiving a new reservation. This it because it would be difficult to adjust a schedule if a new reservation was received. For example, the reservation management server 5 manages a time period between when a reentry request is received and when a next reservation period starts as maintenance time.

It is to be noted that reentry is not always permitted whenever a reentry request is issued before a next reservation period starts. If a reentry request is issued immediately before a next reservation period (e.g., 1 minute before), for example, reentry might inconvenience a next user.

In the present exemplary embodiment, therefore, it is required that a reentry request be issued a predetermined period of time or more (e.g., 30 minutes or more) before a start of a next reservation period. More preferably, it is required that a user who is reentering be able to arrive at the time-based rental space 3 a predetermined period of time or more (e.g., 10 minutes or more) before a start of a next reservation period.

An arrival time may be estimated on the basis of information regarding a position at which the user has issued a reentry request or may be input by the user.

If the user inputs a reentry request from a user interface (e.g., the display device 31M) disposed on the outside wall of the time-based rental space 3 (if it takes no time for the user to arrive at the time-based rental space 3), for example, a time point at which the reentry request has been received may be used.

If the user is located at a place far from the time-based rental space 3, on the other hand, whether a reservation period of a next user will have started may be determined on the basis of time taken for the user to arrive at the time-based rental space 3 from a current position of the user terminal 4.

If a result of step S12 is negative (if the next reservation period has not started), the reentry control unit 101 determines whether it is within a predetermined period of time since a previous reservation period (step S13).

The previous reservation period refers to a reservation period of the user who has issued the reentry request.

This is because necessity to permit reentry for shutout or a lost article decreases as time elapses after an end of a reservation period. A management staff member, for example, might find a lost article and keep the article in another place. In the present exemplary embodiment, the predetermined period of time is, for example, 3 hours.

If a result of step S13 is negative, the reentry control unit 101 ends the operation without performing a series of processing steps relating to reentry, because the time-based rental space 3 is already unavailable.

If the result of S13 is positive, the reentry control unit 101 notifies the user of reentry conditions (step S14).

In the present exemplary embodiment, the reentry conditions include one that the functions available in the time-based rental space 3 are limited and one that the user will be charged after a predetermined period of time (e.g., 3 minutes).

The notification may include details of the limitation. For example, information indicating that illuminance inside the time-based rental space 3 is lower than in a reservation period and gradually decreases over time.

The reentry control unit 101 then determines whether the user has accepted the reentry conditions (step S15).

If a result of S15 is negative (if the user has not accepted the reentry conditions), the reentry control unit 101 ends the operation without performing the series of processing steps relating to reentry.

If the result of step S15 is positive (if the user has accepted the reentry conditions), the reentry control unit 101 determines whether the user who is reentering has been authenticated (step S16). As a result of the authentication, whether the user who is reentering is the user who was using the time-based rental space 3 is checked. The authentication unit 32A (refer to FIG. 5) is used for the authentication. Authentication based on face recognition, fingerprint recognition, an electronic key, or a physical address of the user terminal 4, for example, is performed.

In the authentication based on an electronic key, a dedicated electronic key issued for reentry may be used, or an electronic key that was valid in the reservation period may be used. In the present exemplary embodiment, the user who is reentering is determined to be the user who was using the time-based rental space 3 if a physical address of the user terminal 4 who is reentering is the same as a physical address of the user terminal 4 used in the past reservation period.

Since reentry is permitted to put things away or retrieve a lost article, reentry may be permitted only once.

If a result of step S16 is negative (if the user who is reentering is not the user who was using the time-based rental space 3), the reentry control unit 101 does not permit reentry. That is, the reentry control unit 101 ends the operation without performing the series of processing steps relating to reentry.

If the result of step S16 is positive (if the user who is reentering is the user who was using the time-based rental space 3), the reentry control unit 101 limits the functions (step S17). In the present exemplary embodiment, the functions other than functions relating to unlocking and lighting are disabled. The computer 31E, the air conditioner 31A (refer to FIG. 5), the printing device 31D (refer to FIG. 5), and the display device 31F (refer to FIG. 5), for example, are disabled.

In the present exemplary embodiment, only the lighting device 31C (refer to FIG. 5), the door open/close mechanism 31J (refer to FIG. 5), and the open/close locking mechanism 31K (refer to FIG. 5) are enabled. In the present exemplary embodiment, however, illuminance inside the time-based rental space 3 is lower than in a reservation period.

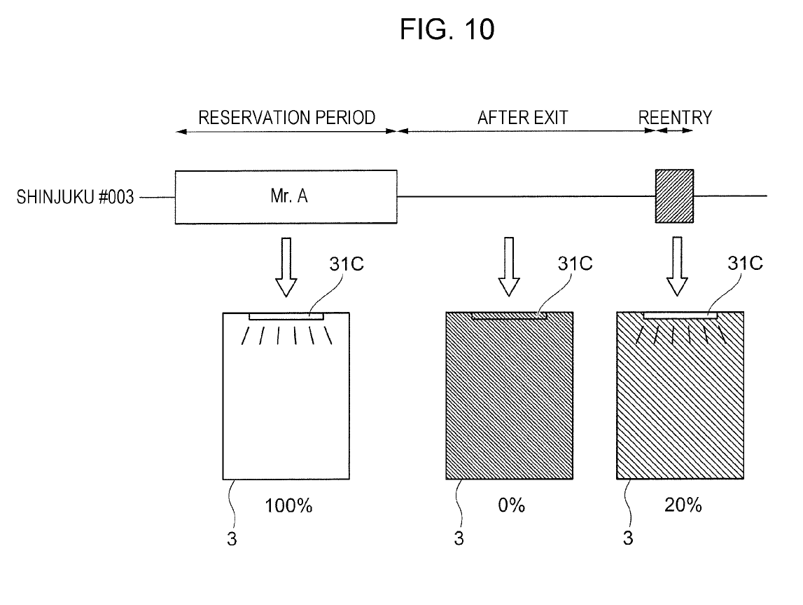

FIG. 10 is a diagram illustrating the limitation of illuminance. FIG. 10 illustrates changes in illuminance inside a time-based rental space 3 managed as “Shinjuku #003”. “Shinjuku #003” indicates that the time-based rental space 3 is located in Shinjuku and managed with a number “#003”.

During a reservation period of Mr. A, the lighting device 31C (refer to FIG. 5) fully turns on (i.e., 100%). The illuminance may be arbitrarily adjusted within a range of 0% to 100% in accordance with the user's preference. The illuminance herein refers to illuminance caused by the lighting device 31C, and an effect of outside light is ignored.

After Mr. A exits, the lighting device 31C turns off. That is, the illuminance is 0%.

If Mr. A reenters the time-based rental space 3, the amount of light of the lighting device 31C is reduced, and the illuminance becomes about 20%. This is because it is sufficient that an illuminance high enough to put things away or retrieve a lost article is secured.

The percentage of 20% is just an example, and any other percentage may be used, instead. For example, the illuminance may be maximum (100%) or may be 0%. This is because, depending on a place where the time-based rental space 3 is installed or a direction of the door 32, outside light comes into the time-based rental space 3 and an illuminance high enough to put things away or retrieve a lost article can be secured.

Because the amount of outside light coming into the time-based rental space 3 can change over time, the lighting device 31C may be adjusted in accordance with an outside environment. For example, the lighting device 31C may be controlled in accordance with an output value of an illuminance sensor, which is not illustrated, provided inside the time-based rental space 3.

Alternatively, the illuminance inside the time-based rental space 3 may be gradually decreased, for example, from 100% to 50%, and then to 30%, 20%, 10%, and 0%. In this case, a user can easily put things away or retrieve a lost article with a high illuminance immediately after reentry and is prompted to finish the work as early as possible under the decreasing illuminance. This mechanism also suppresses use of the time-based rental space 3 for other purposes.

FIG. 9 is referred to again.

Next, the reentry control unit 101 causes the time-based rental space 3 to enter an open state (step S18).

The order of steps S17 and S18 may be switched, or steps S17 and S18 may be performed in parallel with each other.

In the present exemplary embodiment, when the time-based rental space 3 enters the open state, the door 32 is unlocked and remains unlocked, the door 32 is physically opened, and/or a window or a vent, which is not illustrated, is opened.

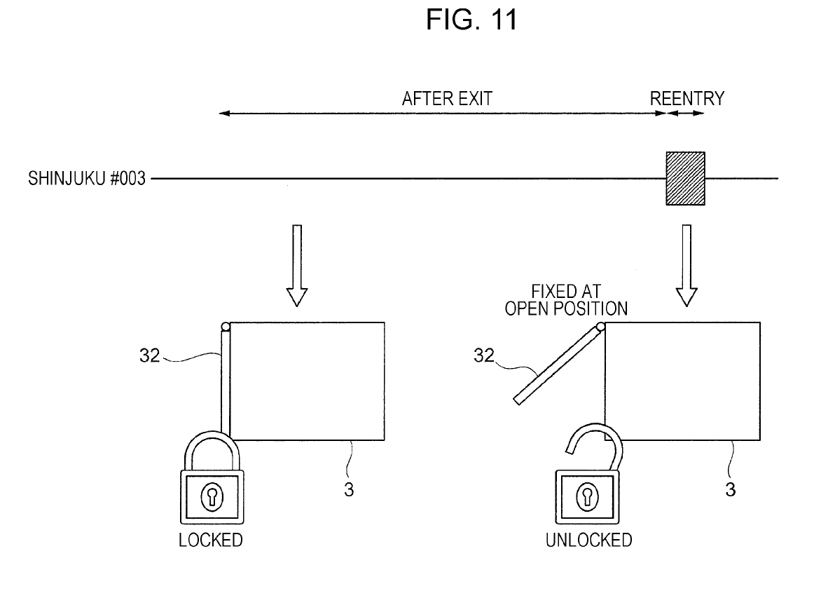

FIG. 11 illustrates the open state. FIG. 11 illustrates an example in which the door 32 (refer to FIG. 2) of the time-based rental space 3 managed as “Shinjuku #003” enters the open state.

As illustrated in FIG. 11, the time-based rental space 3 after Mr. A exits is locked. In the example illustrated in FIG. 11, the door 32 blocks the entirety of an entrance and is locked so that persons other than a user who has a valid key will not enter. In unreserved periods, the entrance is closed so that persons other than users who have reserved the time-based rental space 3 will not enter.

The unlocked door 32 after Mr. A reenters the time-based rental space 3 is fixed at a position wider open than when Mr. A has opened the door 32 at the time of the reentry. This open state continues until Mr. A exits. The exit of Mr. A is detected by the human detection sensor 31B provided inside the time-based rental space 3.

When the door 32 is manually opened, the open/close locking mechanism 31K is controlled such that door 32 can move in an opening direction. As a result, the area of an opening of the entrance can become larger but does not become smaller. When the door open/close mechanism 31J controls the opening and closing of the door 32, on the other hand, the open/close locking mechanism 31K keeps the door 32 at a position opened by the door open/close mechanism 31J.

When the door 32 does not close, the inside of the time-based rental space 3 is exposed to the outside, which is not suitable for types of work that require privacy. As a result, a user who has finished putting things away or retrieving a lost article is prompted to leave the time-based rental space 3. This mechanism also suppresses use of the time-based rental space 3 for other purposes.

FIG. 9 is referred to again.

Next, the reentry control unit 101 determines whether the user who has reentered has exited from the time-based rental space 3 (step S19).

If a result of step S19 is positive (if the user has exited), the reentry control unit 101 ends the series of processing steps.

The exit is detected, for example, by the human detection sensor 31B (refer to FIG. 5). In the present exemplary embodiment, a time point 5 seconds after the human detection sensor 31B has detected the exit is regarded as an exit time in consideration of a detection range and detection accuracy of the human detection sensor 31B.

If charging has already begun at an exit time, the reentry control unit 101 calculates an amount of money according to time elapsed since the charging began and notifies the user who reentered the time-based rental space 3 of the amount of money. In the present exemplary embodiment, a time point at which the human detection sensor 31B has detected exit or a time point 3 seconds before the human detection sensor 31B has detected exit as an exit time.

If the result of step S19 is negative, the reentry control unit 101 determines whether to start charging (step S20). In the present exemplary embodiment, the user has been notified of the predetermined period of time of 3 minutes as a reentry condition. The reentry control unit 101, therefore, monitors whether 3 minutes have elapsed since the human detection sensor 31B or the monitoring camera 31L detected reentry.

If a result of step S20 is negative, the reentry control unit 101 returns to step S19. That is, the reentry control unit 101 repeatedly performs step S20 until the predetermined period of time elapses unless exit is detected.

If the result of step S20 is positive, the reentry control unit 101 starts charging (step S21).

Next, the reentry control unit 101 determines whether there is an additional reservation (step S22).

An additional reservation is selected when a start of a next reservation period allows and the user who has reentered the time-based rental space 3 desires.

In a proper reservation period, lighting and other functions are obviously available, and the user can put things away or retrieve a lost article in a bright environment.

If a result of step S22 is positive (if there is an additional reservation), the reentry control unit 101 cancels the limitation of the functions (step S23) and ends the series of processing steps relating to reentry.

If the result of step S22 is negative, on the other hand, the reentry control unit 101 returns to step S19.

The result of step S22 becomes negative when a next reservation period does not allow an additional reservation or when the user does not desire an additional reservation.

A case where the result of step S12 is positive will be described hereinafter. That is, an operation when a next reservation period has started will be described.

In this case, the reentry control unit 101 determines whether the next user has started using the time-based rental space 3 (step S24).

If the next user has already started using the time-based rental space 3, reentry is not permitted. A result of step S24 becomes positive, and the reentry control unit 101 ends the series of processing steps.

In this case, the next user is asked to put a lost article into a lost article box, and the user who has issued the reentry request is asked to check the lost article box.

If the result of step S24 is negative (i.e., if the next reservation period has started but the next user has not started using the time-based rental space 3), the reentry control unit 101 notifies the next user of the issuance of the reentry request (step S25).

In the present exemplary embodiment, the next user is notified of an alternative time-based rental space 3 along with the issuance of the reentry request.

This is because if there is another time-based rental space 3 that is installed in the same place and that has not been reserved in the same period and the next user accepts to change the reservation to the alternative time-based rental space 3, for example, reentry can be achieved without inconveniencing the next user.

The next user need not be asked to go to a time-based rental space 3 installed in another place because the next user should be given priority. There is of course no reason to avoid asking the next user to go to a time-based rental space 3 installed in another place insofar as the next user will accept to go to the other place.

After step S25, the reentry control unit 101 notifies the user (the user who has issued the reentry request) of an inquiry condition of the next user (step S26).

The notification includes information indicating that the reservation period of the next user has started but the next user has not used the time-based rental space 3. As a result of the notification, the user who has issued the reentry request can understand that he/she can enter the time-based rental space 3 with the next user's (another user's) permission.

The reentry control unit 101 then determines whether the next user has permitted the user to reenter or whether the next user has accepted to change the reservation to the other time-based rental space 3 presented as an alternative (step S27).

If a result of step S27 is negative (if the next user does not permit the user to reenter), the reentry control unit 101 ends the series of processing steps. In this case, as when the result of step S24 has been positive, the next user is asked to put a lost article into the lost article box, and the user who has issued the reentry request is asked to check the lost article box.

If the result of step S27 is positive, on the other hand, the reentry control unit 101 proceeds to step S13.

Examples of Control

Examples of control according to a situation at a time of issuance of a reentry request will be described hereinafter.

### First Example

An example of control when a next reservation period has not started at a time of issuance of a reentry request will be described.

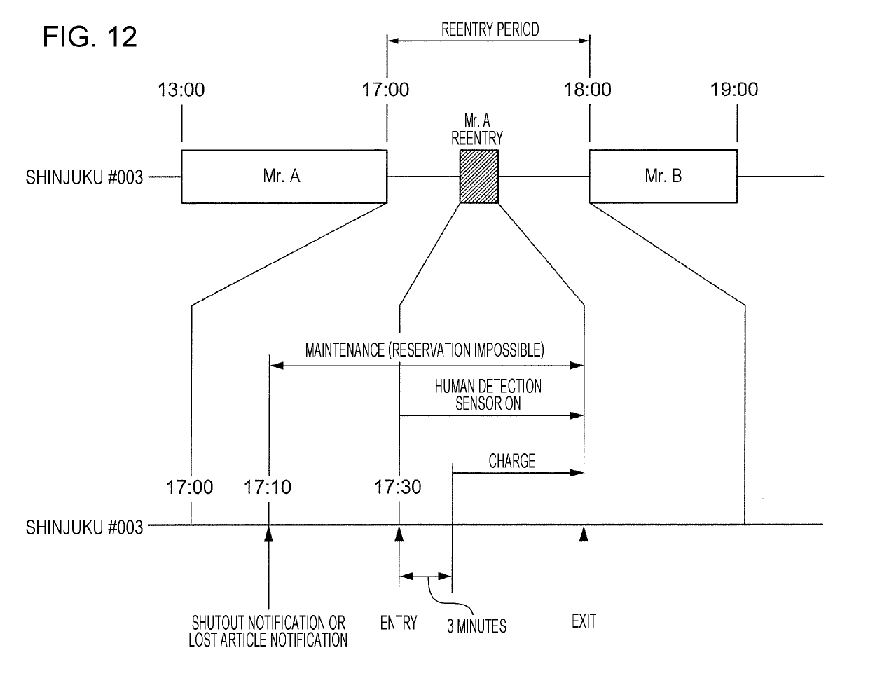

FIG. 12 is a diagram illustrating an example in which a reservation period of Mr. B has not started when Mr. A issues a reentry request.

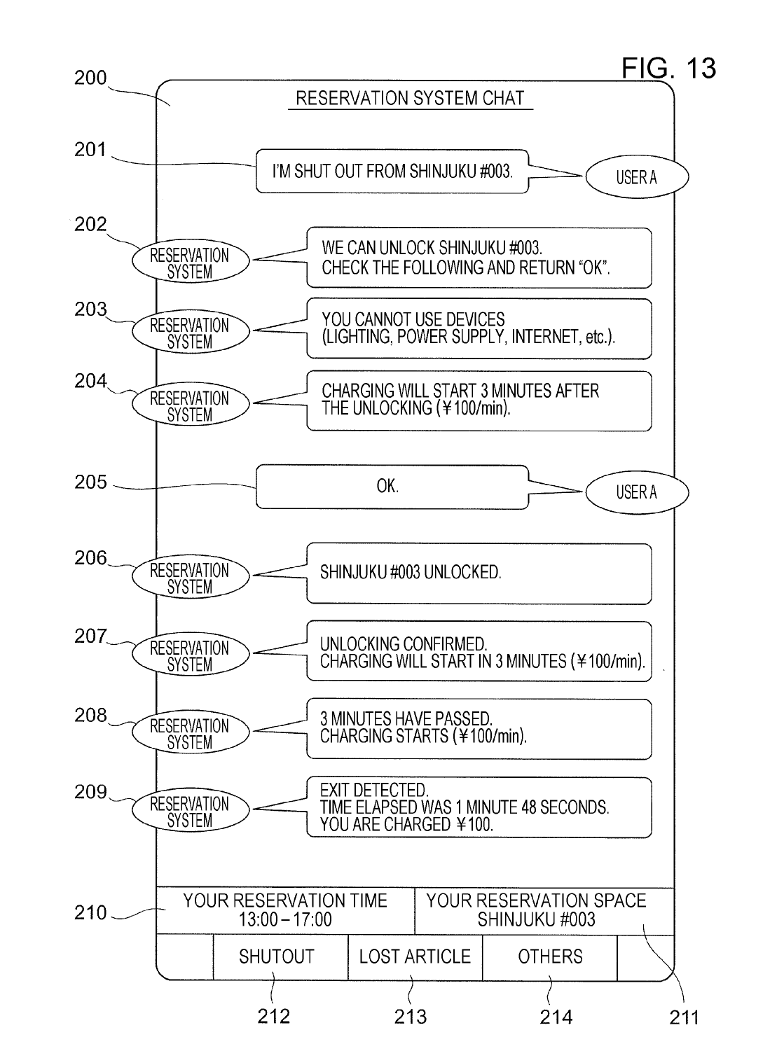

FIG. 13 is a diagram illustrating an example of a chat screen 200 for reservation displayed, during a control process, on the display device 47 (refer to FIG. 3) of the user terminal 4 (refer to FIG. 1) owned by Mr. A, who has issued a reentry request.

This example of control corresponds to a case where the result of step S12 (refer to FIG. 9) is negative. More specifically, this example of control corresponds to a series of processing steps performed after the result of step S12 becomes negative until exit of Mr. A is detected after step S22.

In the example illustrated in FIG. 12, Mr. A has reserved the time-based rental space 3 managed as “Shinjuku #003” from 13:00 to 17:00, and Mr. B has reserved the time-based rental space 3 from 18:00 to 19:00.

There is a gap of 1 hour between an end of the reservation time of Mr. A and a start of the reservation time of Mr. B. That is, between 17:00 and 18:00, reentry is possible and anyone can reserve the time-based rental space 3.

It is assumed in the example illustrated in FIG. 12 that Mr. A issues a shutout notification or a lost article notification at 17:10.

Since no reservation can be made for the time-based rental space 3 that can be reentered in the present exemplary embodiment, the time-based rental space 3 enters maintenance time, in which no reservation is possible, until reentry is canceled or exit is detected.

In the example illustrated in FIG. 12, Mr. A reenters at 17:30. In addition, Mr. A's stay exceeds 3 minutes, and charging starts.

Because Mr. A exits before 18:00, at which the reservation period of Mr. B starts, Mr. B is not inconvenienced.

In this example, Mr. A is charged for his extended stay. Alternatively, because Mr. A's reentry prevents others from reserving the time-based rental space 3, Mr. A may be charged for the reentry itself.

Next, messages displayed on the chat screen 200 illustrated in FIG. 13 will be described in chronological order.

In the present exemplary embodiment, the reentry control unit 101 (refer to FIG. 6) manages the chat screen 200. In the chat screen 200, the reentry control unit 101 as a sender of messages is represented as a “reservation system”.

A reentry operation starts with an operation performed by Mr. A, who is issuing a reentry request, on a shutout button 212.

In FIG. 13, the shutout button 212 is disposed under the chat screen 200. A lost article button 213 and an others button 214 are also disposed at a bottom of the chat screen 200. Two display fields 210 and 211 are provided to indicate the reservation made by Mr. A. The display field 210 indicates that the reservation period of Mr. A is 13:00 to 17:00, and the display field 211 indicates that “Shinjuku #003” has been reserved.

As a result of the operation performed by Mr. A on the shutout button 212, a message 201, “I'm shutout from Shinjuku #003”, is displayed in a first row of the chat screen 200.

The reentry control unit 101 receives the message 201 (step S11 in FIG. 9).

Since reentry is possible in this example, a message 202 indicating that reentry is possible and there are reentry conditions is displayed in a second row of the chat screen 200.

The message 202 says, “We can unlock Shinjuku #003. Check the following and return “OK””. When unlocking is possible, reentry is possible.

Messages 203 and 204 indicating the reentry conditions are displayed in third and fourth rows of the chat screen 200.

The message 203 says, “You cannot use devices”, and indicates a specific example of disabled functions. In the message 203, lighting, a power supply, and the Internet are disabled.

The message 204 says, “Charging starts 3 minutes after the unlocking”, and indicates that Mr. A will be charged 100 yen per minute.

A message 205 indicating that Mr. A has accepted the reentry conditions is displayed in a fifth row of the chat screen 200. A button that is not illustrated is used to accept the reentry conditions. Another button that is not illustrated is also used not to accept the reentry conditions. These buttons may be displayed under the message 204. Because FIG. 13 illustrates the screen after Mr. A accepts the reentry conditions, these buttons are not displayed.

After Mr. A accepts the reentry conditions, the reservation system displays a message 206 indicating that reentry has become possible in a sixth row of the chat screen 200. The message 206 says, “Shinjuku #003 unlocked”.

Mr. A then arrives at “Shinjuku #003”, and authentication for reentry is successfully completed. The reservation system displays a message 207 in a seventh row of the chat screen 200. The message 207 says, “Unlocking confirmed. Charging will start in 3 minutes”, and indicates that Mr. A will be charged 100 yen per minute.

Since it is assumed in this example that Mr. A stays in “Shinjuku #003” more than 3 minutes (refer to FIG. 12), a message 208, “3 minutes have passed. Charging starts”, is displayed as a message 208 in an eighth row of the chat screen 200. The message 208 also indicates that Mr. A will be charged 100 yen per minute.

After Mr. A exits, the reservation system displays a message 209 in an ninth row of the chat screen 200. The message 209 says, “Exit detected. Time elapsed was 1 minute 48 seconds. You are charged ¥100”. In this example, Mr. A is not charged an amount of money corresponding to less than 1 minute.

An example of reentry when a next reservation period has not started has been described.

### Second Example

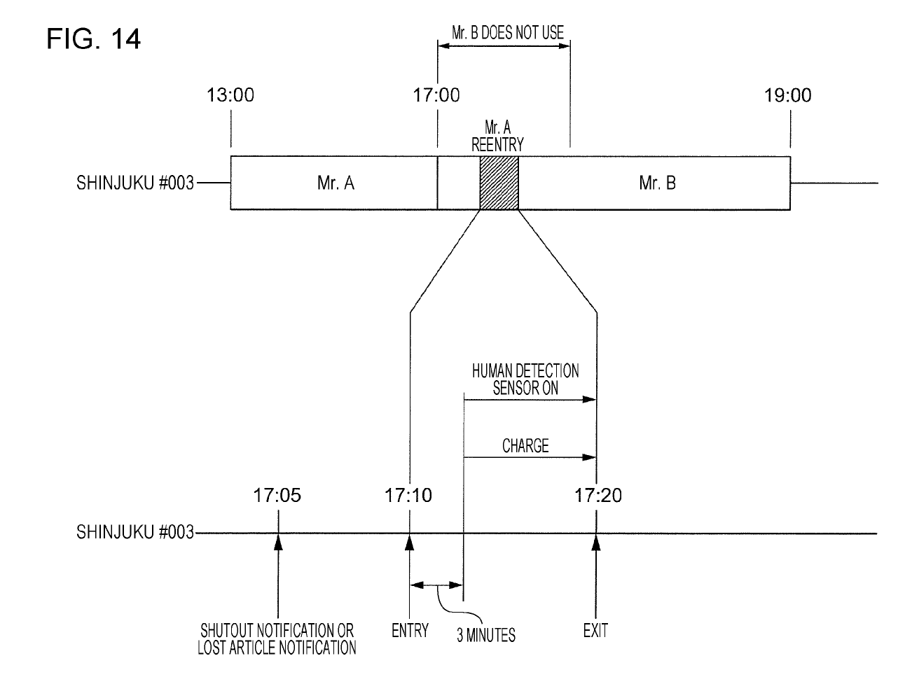

An example in which a next reservation period has started at a time of issuance of a reentry request will be described with reference to FIGS. 14 to 16.

FIG. 14 is a diagram illustrating an example in which a reservation period of Mr. B has started when Mr. A issues a reentry request but Mr. B has not started using the time-based rental space 3.

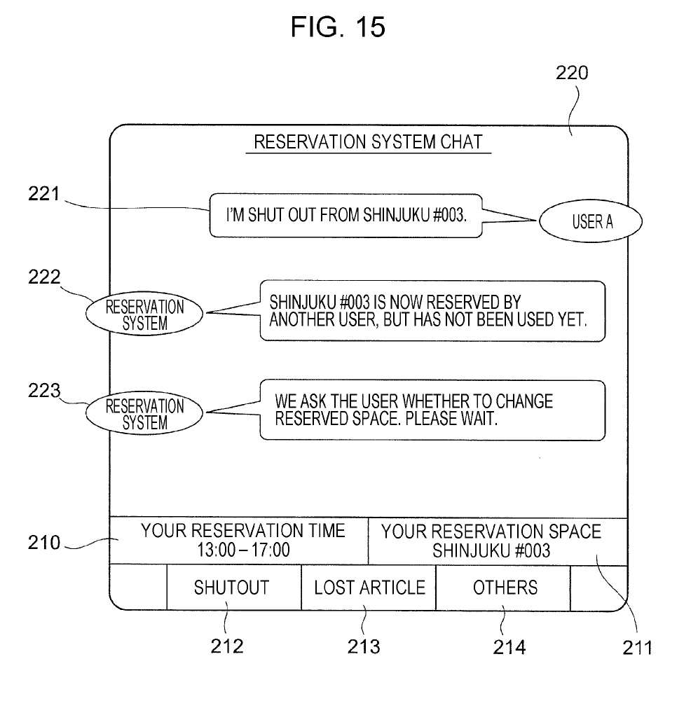

FIG. 15 is a diagram illustrating an example of a chat screen 220 for reservation displayed on the display device (refer to FIG. 3) of the user terminal 4 (refer to FIG. 1) owned by Mr. A, who has issued the reentry request.

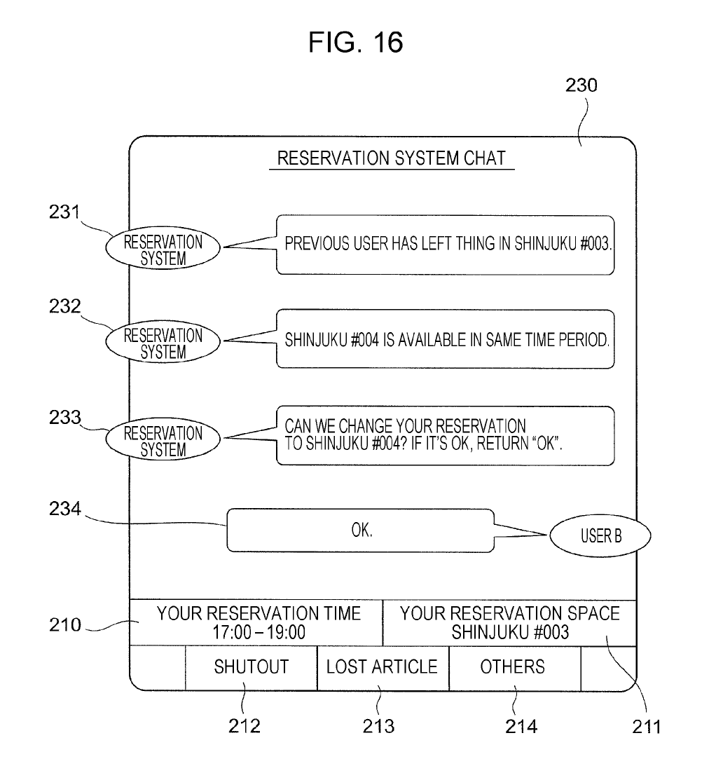

FIG. 16 is a diagram illustrating an example of a chat screen 230 for reservation displayed on the display device 47 of the user terminal 4 owned by Mr. B, who has received a notification of the issuance of the reentry request.

This example of control corresponds to a case where the result of step S12 (refer to FIG. 9) is positive and the result of step S24 is negative. More specifically, this example of control corresponds to a series of processing steps performed when the process proceeds from step S14 to step S27 and exit of Mr. A is detected after steps S14 to S22.

In the example illustrated in FIG. 14, Mr. A has reserved the time-based rental space 3 managed as “Shinjuku #003” from 13:00 to 17:00, and Mr. B has reserved the time-based rental space 3 from 17:00 to 19:00. There is no gap between the reservation periods of Mr. A and Mr. B. In this case, Mr. A is usually not permitted to reenter the time-based rental space 3 managed as “Shinjuku #003”.

In FIG. 14, however, at 17:05, when Mr. A issues a shutout notification or a lost article notification, Mr. B has not started using “Shinjuku #003”. For this reason, Mr. A may be permitted to reenter.

In this case, as described above, Mr. B is notified of the shutout notification or the lost article notification. Depending on the case, Mr. B is also notified of an alternative time-based rental space 3.

In FIG. 14, Mr. B permits Mr. A to reenter or accepts to change the reservation to the alternative time-based rental space 3.

As a result, Mr. A who has accepted reentry conditions reenters the time-based rental space 3 managed as “Shinjuku #003”. Because Mr. A has stayed until 17:20, Mr. A is charged an amount of money corresponding to an excess of 7 minutes.

Next, messages displayed on the chat screen 220 illustrated in FIG. 15 and the chat screen 230 illustrated in FIG. 16 will be described in chronological order.

In this example, too, the reentry control unit 101 (refer to FIG. 6) manages the chat screens 220 and 230.

First, the chat screen 220 displayed on the user terminal 4 (refer to FIG. 1) operated by Mr. A will be described.

As a result of an operation performed by Mr. A on the shutout button 212, a message 221, “I'm shut out from Shinjuku #003”, is displayed in a first row of the chat screen 220.

The reentry control unit 101 receives the message 221 (step S11 in FIG. 9).

Since the reservation period of Mr. B has started but Mr. B has not started using “Shinjuku #003” in this example, messages 222 and 223 indicating that an inquiry to Mr. B is in progress are displayed in second and third rows of the chat screen 220.

The message 222 says, “Shinjuku #003 is now reserved by another user, but has not been used yet”, and the message 223 says, “We ask the user whether to change reserved space. Please wait”.

After Mr. B permits Mr. A to reenter, the chat screen 220 displays the messages 202 and later (refer to FIG. 13).

Next, the chat screen 230 displayed on the user terminal 4 (refer to FIG. 1) operated by Mr. B will be described.

As a result of the detection, by the reservation system, of the operation performed by Mr. A on the shutout button 212, a message 231, “Previous user has left thing in Shinjuku #003”, is displayed in a first row of the chat screen 230.

Next, the reservation system displays a message 232, “Shinjuku #004 is available in same time period”, in a second row of the chat screen 230. “Shinjuku #004” presented as an alternative is provided in the same place as “Shinjuku #003”, and time taken to move from “Shinjuku #003” to “Shinjuku #004” is substantially zero. Mr. B, therefore, is not inconvenienced.

At the same time, the reservation system displays a message 233, “Can we change your reservation to Shinjuku #004? If it's OK, return “OK””, in a third row of the chat screen 230 to prompt Mr. B to answer.

In the example illustrated in FIG. 16, a message 234 indicating that Mr. B has accepted the suggestion is displayed in a fourth row of the chat screen 230.

An example of reentry when a next reservation period has started but a next user has not started using the time-based rental space 3 has been described.

### Third Example

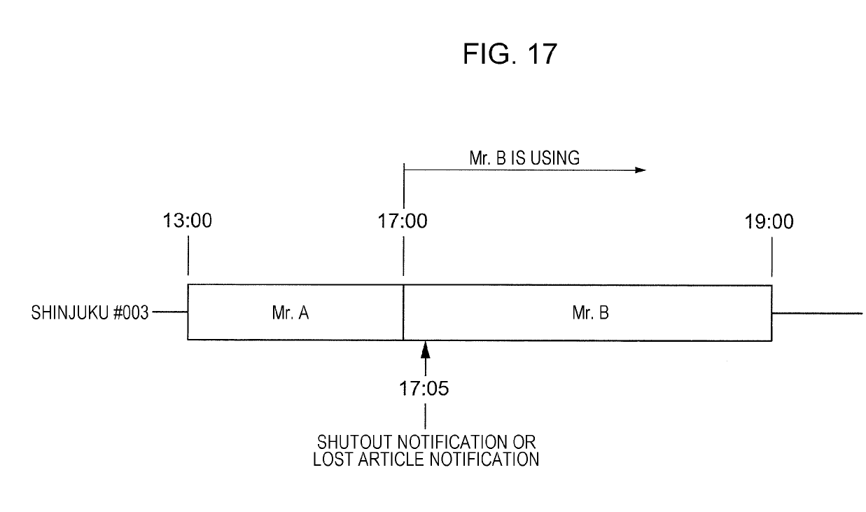

Another example in which a next reservation period has started at a time of issuance of a reentry request will be described with reference to FIGS. 17 to 19.

FIG. 17 is a diagram illustrating an example in which a reservation period of Mr. B has started and Mr. B has started using the time-based rental space 3 when Mr. A issues a reentry request.

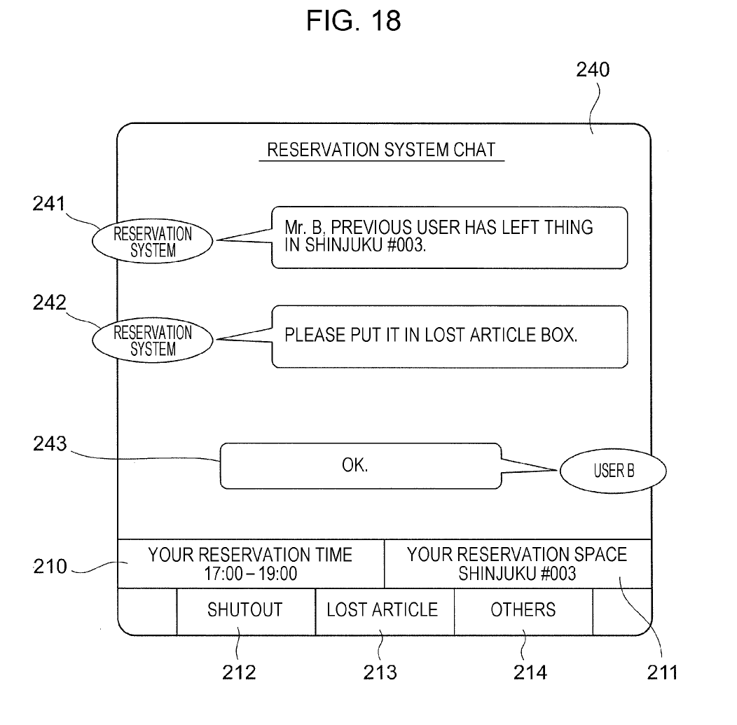

FIG. 18 is a diagram illustrating a chat screen 240 for reservation displayed on the display device 47 (refer to FIG. 3) of the user terminal 4 (refer to FIG. 1) owned by Mr. B, who has received a notification of the issuance of the reentry request.

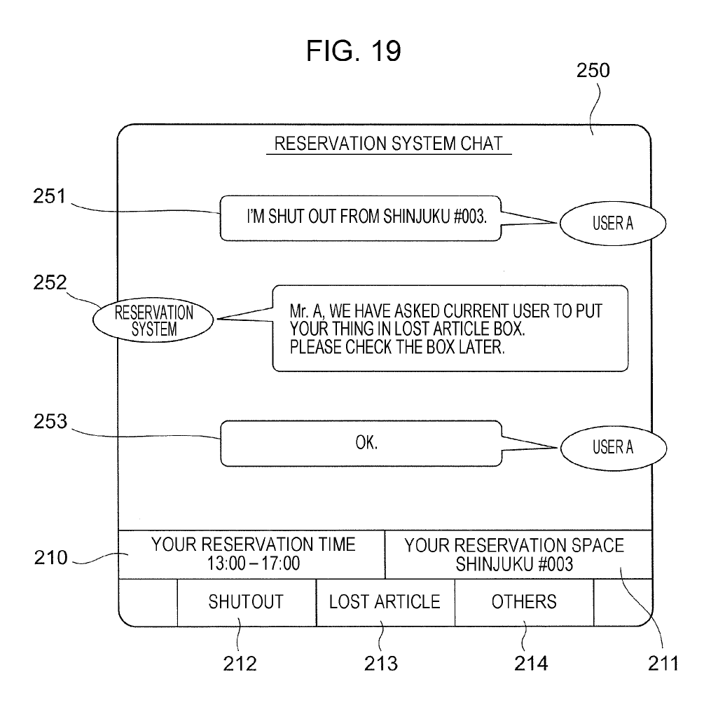

FIG. 19 is a diagram illustrating an example of a chat screen 250 for reservation displayed on the display device 47 of the user terminal 4 owned by Mr. A, who has issued the reentry request.

This example of control corresponds to a case where the result of step S24 (refer to FIG. 9) is positive.

In the example illustrated in FIG. 17, Mr. A has reserved the time-based rental space 3 managed as “Shinjuku #003” from 13:00 to 17:00, and Mr. B has reserved the time-based rental space 3 from 17:00 to 19:00. At 17:05, when Mr. A issues a shutout notification or a lost article notification, Mr. B has started using “Shinjuku #003”.

Next, messages displayed on the chat screen 240 illustrated in FIG. 18 and the chat screen 250 illustrated in FIG. 19 will be described in chronological order.

In this example, too, the reentry control unit 101 (refer to FIG. 6) as a reservation system manages the chat screens 240 and 250.

First, the chat screen 240 displayed on the user terminal 4 (refer to FIG. 1) operated by Mr. B will be described.

A message 241 from the reservation system, “Mr. B, previous user has left thing in Shinjuku #003”, is displayed in a first row of the chat screen 240.

Because Mr. A is not permitted to reenter, a request to Mr. B, namely a message 242, “Please put it in lost article box”, is displayed in a second row of the chat screen 240.

In this example, a message 243 indicating that Mr. B has accepted the request is displayed in a third row of the chat screen 240.

Next, a chat screen 250 displayed on the user terminal (refer to FIG. 1) operated by Mr. A will be described.

A message 251, “I'm shut out from Shinjuku #003”, is displayed in a first row of the chat screen 250.

In response to the message 251, the reservation system displays a message 252, “Mr. A, we have asked current user to put your thing in lost article box. Please check the box later”, in a second row of the chat screen 250.

In this example, a message 253 indicating that Mr. A has acknowledged the message 252 is displayed in a third row of the chat screen 250.

An example in which a next reservation period has started and a next user has started using the time-based rental space 3 has been described.

### Effects Produced by Exemplary Embodiment

With the method described in the above exemplary embodiment, reentry becomes possible while giving priority to a next user even if a user has been shut out from the time-based rental space 3 or left a thing in the time-based rental space 3.

By determining limitation of functions and occurrence of charging after the reentry as reentry conditions, use of the time-based rental space 3 for other purposes can be suppressed.

Although there is no difference in processing between a shutout notification and a lost article notification in the present exemplary embodiment, a difference may be provided depending on a type of notification, instead. For example, a period of time taken until charging occurs may be different.

### MODIFICATIONS

Although an exemplary embodiment of the present invention has been described above, the technical scope of the present invention is not limited to the above exemplary embodiment. It is evident from the claims that the technical scope of the present invention also includes modes obtained by modifying or improving the above exemplary embodiment in various ways.

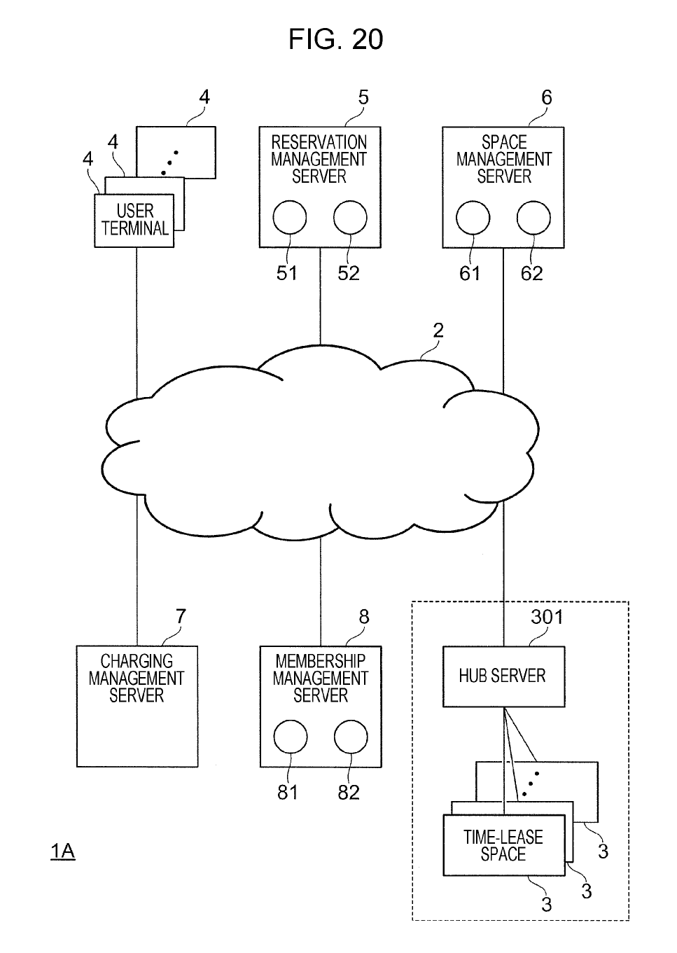

The management system 1 (refer to FIG. 1), for example, is not limited to the above-described configuration. FIG. 20 is a diagram illustrating an example of the configuration of a management system 1A. In FIG. 20, the same components as those illustrated in FIG. 1 are given the same reference numerals. The management system 1A is different from the management system 1 (FIG. 1) in that a hub server 301 that manages plural time-based rental spaces 3 is used. The hub server 301, which has the configuration of a computer, may perform the function of the reentry control unit 101 (refer to FIG. 6) by executing a program. In this sense, the hub server 301 is an example of an apparatus in the claims.

Although a soundproof chamber is assumed as a time-based rental space 3 in the above exemplary embodiment as illustrated in FIG. 2, the time-based rental space 3 may be a rental meeting room, a rental study room, or one of various guest rooms, insofar as the above-described situations occur during use.

Although the door 32 can be locked in the above exemplary embodiment, the above-described control function may be used when the door 32 is not lockable.

Although a time-based rental space is assumed in the above exemplary embodiment, a space need not necessarily be rented on the basis of time.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An apparatus comprising:
a limiting unit that, if a user who has used a space reenters the space after a reservation period ends, limits functions available in the space after reentry.

2. The apparatus according to claim 1,
wherein the limiting unit disables functions other than lighting.

3. The apparatus according to claim 1,
wherein the limiting unit sets an illuminance of the lighting lower than an illuminance during the reservation period.

4. The apparatus according to claim 3,
wherein the limiting unit gradually decreases the illuminance of the lighting.

5. The apparatus according to claim 1,
wherein the limiting unit keeps an entrance of the space in an open state after the reentry until the user exits.

6. The apparatus according to claim 5,
wherein the open state is a state in which the user is able to go in and out of the space.

7. The apparatus according to claim 5,
wherein the limiting unit fixes a door at a position widest open at a time of the reentry.

8. The apparatus according to claim 1,
wherein the limiting unit keeps a closable opening provided for the space in an open state after the reentry until the user exits.

9. The apparatus according to claim 1,
wherein the reentry is permitted if another reservation period of the space has not started at a time of issuance of a reentry request.

10. The apparatus according to claim 9,
wherein the reentry is permitted if the reentry request is issued within a predetermined period of time since an end of the reservation period of the user who has issued the reentry request.

11. The apparatus according to claim 9,
wherein the reentry is permitted if the user who has issued the reentry request accepts to exit before another reservation period starts.

12. The apparatus according to claim 1,
wherein the reentry is permitted if there is no other user in the space at a time of issuance of a reentry request.

13. The apparatus according to claim 1,
wherein the reentry is permitted if the user who has issued a reentry request accepts charging after the reentry.

14. The apparatus according to claim 1,
wherein, if another reservation period of the space has started at a time of issuance of a reentry request but another user has not started using the space, the other user is asked whether to accept the reentry.

15. The apparatus according to claim 14,
wherein the reentry is permitted if the other user accepts the reentry.

16. The apparatus according to claim 1,
wherein, if another reservation period of the space has started at a time of issuance of a reentry request but another user has not started using the space, another space is presented to the other user.

17. The apparatus according to claim 16,
wherein the other space is presented in the same space as the space that has been reserved.

18. The apparatus according to claim 1,
wherein the reentry is permitted if a terminal used for the reentry is the same as a terminal that has been used to enter the space during the reservation period.

19. An apparatus comprising:
a reception unit that receives a request to reenter a space after a reservation period ends; and
a notification unit that notifies a user of a reentry condition.

20. The apparatus according to claim 19,
wherein the reentry condition is limitation of functions available in the space after reentry.

21. The apparatus according to claim 20,
wherein the limitation is disablement of functions other than lighting.

22. The apparatus according to claim 20,
wherein the limitation is a decrease in an illuminance of the lighting.

23. The apparatus according to claim 19,
wherein the reentry condition is that the space be kept in an open state.

24. The apparatus according to claim 19,
wherein the reentry condition is charging.

25. The apparatus according to claim 24,
wherein the notification unit notifies the user of a start of the charging.

26. The apparatus according to claim 19,
wherein, if another reservation period of the space has started at a time of issuance of a reentry request but another user has not started using the space, the notification unit notifies the user that the other user has reserved the space but has not started using the space.

27. The apparatus according to claim 26,
wherein the notification unit notifies the user of an inquiry condition of the other user.

28. An apparatus comprising:
a notification unit that notifies a user of issuance of a request to reenter a reserved space; and
a reception unit that receives whether to accept reentry.

29. The apparatus according to claim 28,
wherein an alternative available space is presented.

30. A management system comprising:
a database storing space management data; and
a limiting unit that, if a user who has used a space reenters the space after a reservation period ends, limits functions available in the space after reentry.

31. A non-transitory computer readable medium storing a program causing a computer to function as:
a limiting unit that, if a user who has used a space reenters the space after a reservation period ends, limits functions available in the space after reentry.
